(19) United States
(12) Patent Application Publication
(10) Pub. No.: US 2007/0112492 A1
(43) Pub. Date: May 17, 2007

(54) Vehicle entry system and entry controlling method

(75) Inventors: Hitoshi Hyodo, Okazaki-shi (JP); Hiroki Nasuda, Obu-shi (JP); Masaki Ito, Hamamatsu-shi (JP); Osamu Fujimoto, Nisshin-shi (JP); Tomohiro Muramatsu, Nagoya-shi (JP)

Correspondence Address: BUCHANAN, INGERSOLL & ROONEY PC, POST OFFICE BOX 1404, ALEXANDRIA, VA, 22313-1404, US

(73) Assignees: Aisin Seiki kabushiki Kaisha, Kariya-shi (JP); Toyota Jidosha Kabushiki Kaisha, Toyota-shi (JP)

(21) Appl. No.: 11/594,131

(22) Filed: Nov. 8, 2006

(30) Foreign Application Priority Data
Nov. 15, 2005 (JP) 2005-330272

(51) Int. Cl. G06F 17/00

(52) U.S. Cl. 701/49; 701/2

(57) ABSTRACT

A vehicle entry system includes a portable device including a transmitter executing a communication between the portable device and a vehicle, approach detecting device detecting an approach to the vehicle of a specific passenger possessing the portable device, by way of receiving an identification code of the specific passenger from the transmitter, first adjusting device adjusting a state of a seat of the vehicle, second adjusting device adjusting a state of a steering device of the vehicle, memorizing device memorizing a state of the seat and a state of the steering device suitable for the specific passenger, control device controlling the first adjusting device in order to adjust the seat so as to be in the memorized state and controlling the second adjusting device in order to adjust the steering device so as to be in the memorized state.

### CROSS REFERENCE TO RELATED APPLICATIONS

This application is based on and claims priority under 35 U.S.C. § 119 to Japanese Patent Application 2005-330272, filed on Nov. 15, 2005, the entire content of which is incorporated herein by reference.

### FIELD OF THE INVENTION

The present invention relates to a vehicle entry system and an entry controlling method for controlling a seat and a steering wheel including a steering wheel and a steering column of a vehicle so as to be in specific states.

### BACKGROUND

It has been considered that adjusting a driver's seat to a state that is suitable for the body type of a driver is important. Many vehicles include an adjustable seat and an adjustable steering device at the driver's seat. Some of them have a power seat device for adjusting the state of the seat by means of a motor.

Specifically, states of the seat in a front-rear direction and a up-down direction, an angle of the seat back, and angle of the steering device including a steering wheel and a steering column, a telescopic movement of the steering column and the like are adjusted so as to be in states that are suitable for the body type of the driver.

A vehicle door that can be unlocked by a wireless IC tag or the like, without using a key, has been put to practical use. According to the configuration of such vehicle door, because a driver having the wireless IC tag is recognized, a seat, a steering device and the like are adjusted so as to be in states that are suitable for the recognized driver.

For example, according to JP2794608B2 A, a seat is adjusted on the basis of a signal of driver's information transmitted from the wireless IC tag or the like. The signal is received by a receiving portion of the vehicle, and the information in the signal is analyzed at an analyzing portion of the vehicle. On the basis of the analyzed information, a door lock system is actuated so as to unlock the door, at the same time, a power seat system is actuated by a control device so as to adjust the seat, the seat back and the like to be in states that are suitable for the driver, the states being memorized in a memorizing means. When a detecting means detects that the doors is operated to be opened while the seat has been adjusted, the control device stops to adjust the seat and the seat back until the detecting means detects that the passenger has entered the vehicle.

However, when the seat has not been adjusted before the driver has entered the vehicle, the driver has to be seated on the seat that is not suitable for the body type of the driver. Thus, it has been considered that, when the driver needs to get into the vehicle quickly, it is better the seat is adjusted so as to be in the registered state, and this operation is completed before the driver enters the vehicle. According to JP2794608B2, if the adjustment of the seat has not been completed during the time period after the door is unlocked until the door is operated to be opened, the driver has to further adjust the seat so as to be in the state that is suitable for the driver after he/she is seated on the seat.

Further, according to JP2794608B2, the seat starts to be adjusted at the time that the door lock is unlocked, however, when the driver A, who has been driving for a long time, takes rest, and a driver B replaces the driver A without locking the door, because the state of the seat has been set to be in the state that is suitable for the driver A, the driver B has to manually operate the seat so as to be in a state that is suitable for him/her, or has to drive on the seat which state is suitable for the driver A.

A need thus exists to provide a vehicle entry system by which the state of the seat or the like can be adjusted until a passenger gets into the vehicle so as be in a state that is suitable for the specific driver so that the passenger can smoothly enter the vehicle.

### SUMMARY OF THE INVENTION

According to an aspect of the present invention, a vehicle entry system includes a portable device having a transmitter executing a communication between the portable device and a vehicle, approach detecting means detecting an approach to the vehicle of a specific passenger possessing the portable device, by way of receiving an identification code of the specific passenger outputted by the transmitter of the portable device to the vehicle, first adjusting means adjusting a state of a seat of the vehicle, second adjusting means adjusting a state of a steering device of the vehicle, memorizing means memorizing a state of the seat and a state of the steering device suitable for the specific passenger, control means controlling the first adjusting means in order to adjust the seat so as to be in the memorized state that is suitable for the specific passenger and controlling the second adjusting means in order to adjust the steering device so as to be in the memorized state that is suitable for the specific passenger, at a timing when the approach detecting means receives the identification code of the specific passenger approaching the vehicle.

According to another aspect of the present invention, a vehicle entry system includes a portable device having a transmitter executing a communication between the portable device and a vehicle, approach detecting means detecting an approach to the vehicle of a specific passenger possessing the portable device, by way of receiving an identification code of the specific passenger outputted by the transmitter of the portable device to the vehicle, first adjusting means adjusting a seat of the vehicle, second adjusting means adjusting a steering device of the vehicle, memorizing means memorizing a state of the seat and a state of the steering device suitable for the specific passenger, an approach detecting process in which the approach detecting means receives the identification code of the specific passenger approaching the vehicle; and a control process in which the first adjusting means is controlled in order to adjust the seat so as to be in the memorized state that is suitable for the specific passenger and the second adjusting means is controlled in order to adjust the steering device so as to be in the memorized state that is suitable for the specific passenger, at a timing when the identification code of the specific passenger approaching the vehicle is detected in the approach detecting process.

### BRIEF DESCRIPTION OF THE DRAWINGS

The foregoing and additional features and characteristics of the present invention will become more apparent from the following detailed description considered with reference to the accompanying drawings, wherein:

FIG.1 illustrates a conceptual schematic view of the vehicle entry system related to the embodiment of the present invention;

FIG.2 illustrates a block diagram indicating a configuration of the vehicle body control device 2 related to the embodiment of the present invention;

FIG.3 illustrates a conceptual diagram of an actuation of the vehicle entry system related to the embodiment of the present invention; and

FIG.4 illustrates a flowchart indicating an example of an actuation of the vehicle entry system 1 related to the embodiment of the present invention.

### DETAILED DESCRIPTION

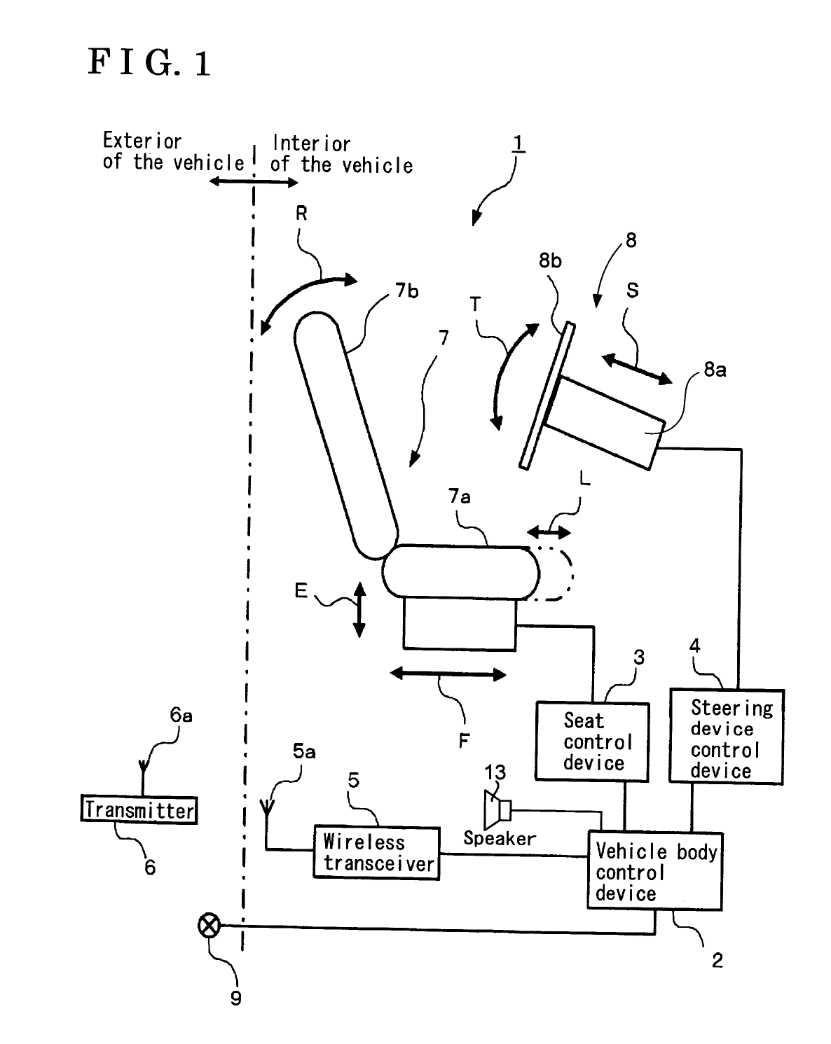

An embodiment of a vehicle entry system according to the present invention will be explained in accordance with the attached drawings. FIG.1 illustrates a conceptual schematic view of a vehicle entry system according to the embodiment of the present invention.

The vehicle entry system 1 illustrated in FIG.1 includes a driver's seat 7, a seat control device 3, serving as a first adjusting means, and a steering device control device 4, serving as a second adjusting means. Specifically, the seat control device 3 adjusts the state of the seat 7, and the steering device control device 4 adjusts an angle of a steering device 8, which includes a steering wheel 8b and a steering column 8a. More specifically, the seat control device adjusts the seat 7 in a front-rear direction F and an upper-lower direction E and adjusts a reclining angle R of the seat back 7b. A length L of the seat surface 7a of the seat 7 may be adjusted by the seat control device 3. Further, the seat 7 may be rotated so as to face an opening portion of the vehicle door so that the driver can smoothly be seated on the seat 7.

The steering device control device 4 adjusts the tilt angle T of the steering wheel 8b and the steering column 8a of the steering device 8, in a direction S of the telescopic movement of the sheering column of the steering device 8 (as known as a telescopic direction).

A vehicle body control device 2, serving as a control means, is connected to each of the seat control device 3 and the steering device control device 4. The vehicle body control device 2 memorizes states of the seat 7 and the steering device 8 that are suitable for the a driver and instructs the seat control device 3 and the steering device control device 4 in order to control the seat 7 and the steering device 8 so as to be in the memorized states.

Further, a wireless transceiver 5, serving as an approach detecting means, is connected to the vehicle body control device 2. The wireless transceiver 5 outputs request signals to a transmitter 6, serving as a portable device, in order to request to send an identification code. The transmitter 6 responds to the identification code request signal sent by the wireless transceiver 5 and outputs the identification code. Then, the wireless transceiver 5 receives the identification code outputted by the transmitter 6. The received identification code is transmitted to the vehicle body control device 2.

An electric wave used for a communication between the wireless transceiver 5 and the transmitter 6 is relatively weak, thus the communication distance between the wireless transceiver 5 and the transmitter 6 is limited. The distance between the transceiver 5 and the transmitter 6 is set to be of a couple of meters, or less than one meter. An antenna 5a of the wireless transceiver 5 is provided at the vicinity of the vehicle door at the driver's seat. Further, the wireless transceiver 5 outputs the identification code request signal at an interval of between 100 milliseconds and 10 seconds. The transmitter 6 is mounted to a controller (some type of a key) used for a keyless entry system. Such controller is normally possessed by a specific driver. In this configuration, the wireless transceiver 5 detects that a driver, who possesses the transmitter 6 for sending a specific identification code, approaches the vehicle door at the driver's seat within, for example 1 to 1.5 meters.

The vehicle body control device 2 verifies the identification code sent by the wireless transceiver 5 by matching to a registered identification code, which is prepared in advance. When the identification code, sent by the wireless transceiver 5, matches the registered identification code, it is determined that the specific driver is approaching the vehicle door, then the seat 7 and the steering device 8 are controlled so as to be in registered states. Plural identification codes may be registered in the vehicle body control device 2. In this configuration, plural drivers are recognized by matching the identification code sent by the wireless transceiver 5 to each of the registered plural identification code.

Further, a lamp 9, serving as an illuminating means, and a speaker 13 are connected to the vehicle body control device 2. The lamp 9 illuminates a bottom portion of the driver's door, specifically, when the vehicle body control device 2 determines that the specific driver is approaching the vehicle driver's door, the illuminating means illuminates the bottom portion of the door in a manner where a color and flashing intervals are selected depending on the specific passenger. Further, in addition to the illuminating means, the control means outputs a selected sound, such as a melody or a music, through a speaker 13 connected to the output portion 26. Specifically, when the door at the driver's seat is opened, the sound indicating the specific passenger and being memorized at the memorizing means is outputted through the speaker.

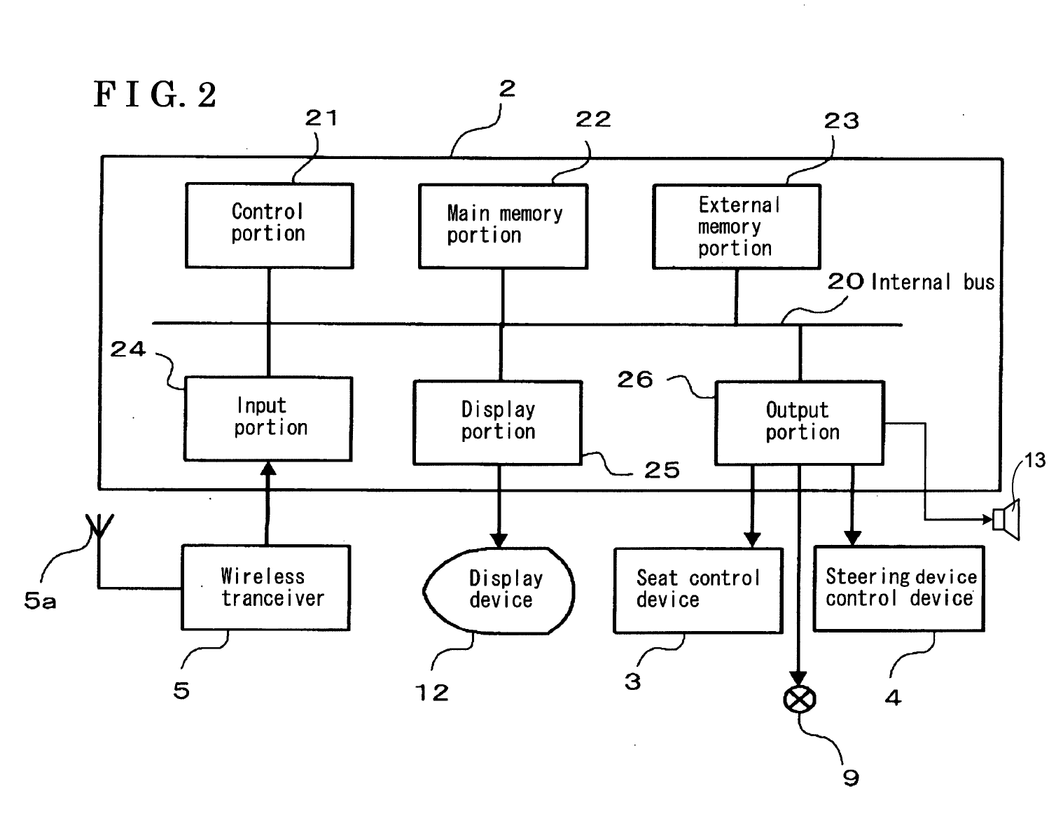

FIG.2 illustrates a block diagram indicating a configuration of the vehicle body control device 2. The configuration of each part of the vehicle body control device 2 will be explained in accordance with FIG.2. As shown in FIG.2, the vehicle body control device 2 includes a control portion 21, a main memory portion 22, an external memory portion 23 (e.g., serving as a memorizing means), an input portion 24, a display portion 25 and an output portion 26. Each of the main memory portion 22, the external memory portion 23, the input portion 24, the display portion 25 and the output portion 26 is connected to the control portion 21 by means of an internal bus 20

The control portion 21 is composed of CPU (Central Processing Unit) and the like, in accordance with a program memorized in the memory portion 23, a process for adjusting the seat 7 and the steering device 8 will then be executed.

The main memory portion 22 is composed of RAM (Random-Access Memory). The control portion 21 loads a program memorized in the external memory portion 23 and executes the program within the main memory portion 22.

The external memory portion 23 is composed of a nonvolatile memory such as ROM (Read Only Memory), a flash memory, a hard disc, DVD-RAM (Digital Versatile Disc Random-Access Memory) or the like. The program for executing the aforementioned process by the control portion 21 is memorized in the external memory portion 23, and data memorized by this program is outputted to the controls portion 21, and the data outputted by the control portion 21 is memorized in the external memory portion 23. Especially, data related to states of each driver is memorized in the external memory portion 23.

The input portion 24 is composed of a serial interface or LAN (Local Area Network) interface, both of which are connected to the wireless transceiver 5. The identification code outputted by the wireless transceiver 5 is transmitted to the control portion 21 via the input portion 24 and the internal bus 20.

The display portion 25 is composed of an interface connected to a display device 12 formed of a light emitting diode, CRT, or LCD (Liquid Crystal Display). The control portion 21 operates the display device 12 through the display portion 25 to display information so that the user recognizes that a specific driver is approaching the vehicle or display an operating condition to adjust the seat 7 and the steering device 8.

The output portion 26 is composed of a serial interface or LAN (Local Area Network) interface, both of which are connected to the seat control device 3 and the steering device control device 4. The control portion 21 outputs to each of the seat control device 3 and the steering device control device 4 an instruction for adjusting the seat 7 so as to be in a state that is suitable for the driver (seat control actuation) or an instruction for adjusting the steering device 8 so as to be in a state that is suitable for the driver (steering device control actuation). Further, the control portion 21 receives a signal indicating that the seat control actuation or the steering device control actuation has been accomplished.

The lamp 9 is connected to the output portion 26. The control portion 21 controls the lamp 9 by means of the output portion 26 to be turned on or off in a selected color.

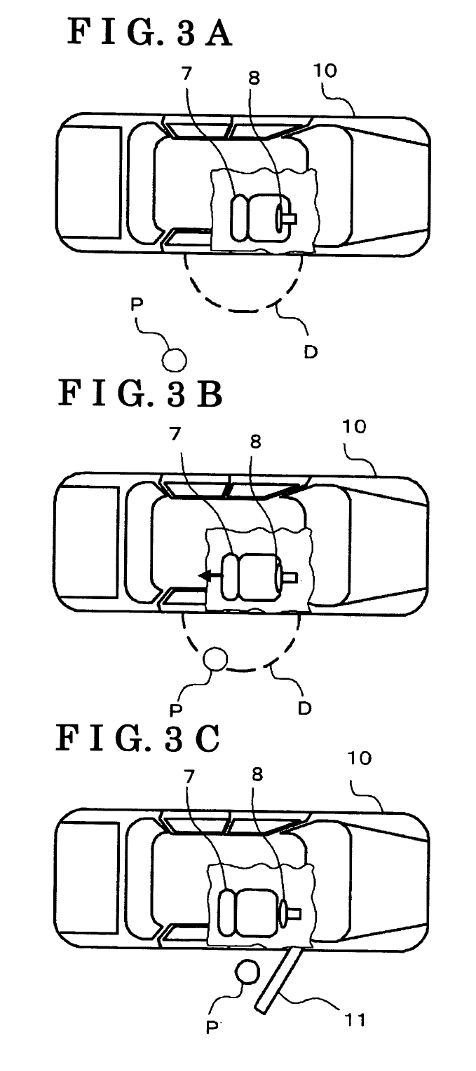

FIG.3 illustrates a conceptual diagram of an actuation of the vehicle entry system related to the embodiment of the present invention. Specifically each of FIG.3(a), FIG.3(b) and

FIG.3(c) illustrates a flat diagram indicating an actuations of the seat 7 and the steering device 8 at the driver's seat when a specific driver P is approaching the vehicle 10 so as to be in a detect area D.

As shown in FIG.3(a), because the driver P exits outside of the detect area D, the identification code request signal outputted by the wireless transceiver 5 does not reach the transmitter 6, or the identification code signal outputted by the transmitter 6 as a response does not reach the wireless transceiver 5. In both conditions, the seat 7 and the steering device 8 remain at a state in which the driver had been was recently seating in.

As shown in FIG.3(b), when the driver P enters within the detect area D, the wireless transceiver 5 receives the identification code signal outputted by the transmitter 6 in order to detect that the driver P is approaching the vehicle. At this point, each of the seat 7 and the steering device 8 is actuated so as to be in the state that is suitable for the driver P. As can be seen in FIG.3(b), the seat 7 is slid backward and the steering device 8 is tilted upward.

As shown in FIG.3(c), when the driver P opens the door 11 in order to enter the vehicle 10, the seat 7 and the steering device 8 have already been adjusted to states that are suitable for the driver P. In this way, after the driver P opens the door 11, the driver P does not need to wait for the seat 7 and the steering device 8 to be adjusted to the states for the driver P, in other words, the driver P can be seated on the seat 7 and in front of the steering device 8, both of which has already been adjusted so as to be in the state that is suitable for the driver P.

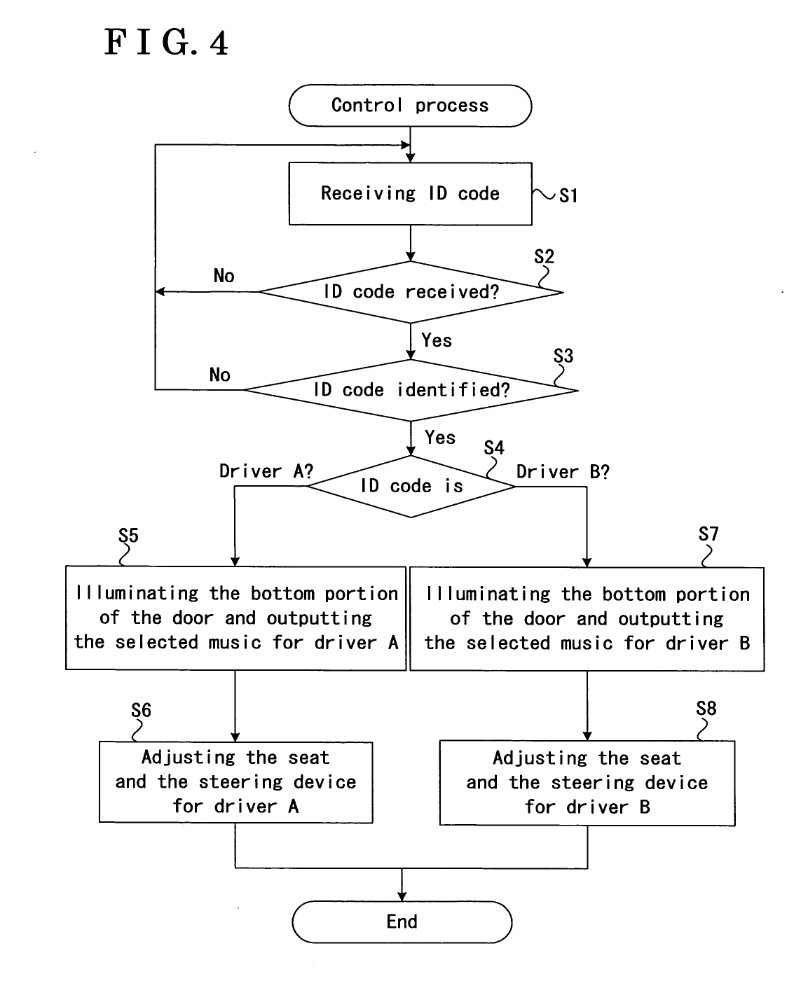

Next, an actuation of the vehicle body control device 2 provided at the vehicle entry system 1 illustrated in FIG.1 and FIG.2 will be explained. FIG.4 illustrates a flowchart indicating an example of an actuation of the vehicle entry system 1 related to the embodiment of the present invention (approach detecting process). As mentioned above, the actuation of the vehicle body control device 2 is executed by the control portion 21 in collaboration with the main memory portion 22, the external memory portion 23, the input portion 24, the display portion 25, the output portion 26, the wireless transceiver 5, the seat control device 3 and the steering device control device 4.

An approach detecting process will be explained below. As shown in FIG.4, the control portion 21 stands by a signal indicating that the identification code is sent by the wireless transceiver 5 (Step S1, Step S2; No). When the identification code is transmitted by the wireless transceiver 5 via the input portion 24 (Step S2; Yes), the control portion 21 determines whether or not the received identification code is identical to a registered identification code, which has been registered in the external memory portion 23 in advance.

When the received identification code is not identical to the registered identification code in the external memory portion 23 (Step S3; No), the received identification code is omitted, and the control portion 21 stands by again to receive another identification code from the wireless transceiver 5 (Step S1). When the received identification code is identical to the registered identification code in the external memory portion 23 (Step S3; Yes), the control portion 21 verifies a driver on the basis of the identification code (Step S4).

A control process will be explained below. When the identification code is identical to a registered identification code for a driver A (Step S4; driver A), the vehicle body control device 2 illuminates a bottom portion of the door, the illumination being customized for the driver A (Step S5). When the identification code is identical to the registered identification code for the driver A, the control device 2 also controls the speaker 13 to output the selected sound, which indicates the driver A and memorized in the external memory portion 23 (Step S5). Then, the states of the seat 7 and the steering device 8 that are suitable for the driver A are read from the external memory portion 23 and outputted to the seat control device 3 and the steering device control device 4 by means of the output portion 26. Thus, the seat 7 and the steering device 8 are adjusted so as to be in the memorized states for the driver A (Step S6).

When it is detected that the identification code is identical to a registered identification code a driver B (Step S4; driver B), the vehicle body control device 2 starts driver B's customized illumination of the bottom portion of the door (Step S7). When the identification code is identical to a registered identification code for the driver B, the control device 2 also controls the speaker 13 to output the selected sound indicating the driver B and memorized in the external memory portion 23 (Step S7). Then, the memorized states of the seat 7 and the steering device 8 for driver B are read from the external memory portion 23 and outputted to the seat control device 3 and the steering device control device 4 by means of the output portion 26. Thus, the seat 7 and the steering device 8 are adjusted so as to be in the memorized state for the driver B (Step S8).

At the same time that the control portion 21 controls the seat 7 and the steering device 8 so as to be in the states that are suitable for the driver, the control portion 21 controls the display device 12 to display a notification that the driver A or B is approaching the vehicle or display an condition to adjust the seat 7 and the steering device 8.

In the actuation flowchart illustrated in FIG.4, the driver A and the driver B are detected, however, one or more than two registered drivers may be detected.

As shown in FIG.3 and FIG.4, according to the vehicle entry system 1 of the present invention, when a specific driver is approaching the driver's door of the vehicle 10, the driver's seat 7 and steering device 8 are actuated so as to be in the registered approaching driver's state. As shown in FIG.3, the seat 7 and the steering device 8 have been adjusted so as to be in the states that are suitable for the driver P while the driver P enters the detect area D and opens the vehicle's door to enter the vehicle. In this way, the driver P doesn't need to wait for the seat 7 and the steering device 8 to be moved to the states for the driver P after he or she opens the vehicle door, in other words, the driver P can be seated on the seat 7 which has already been adjusted to the state that is suitable for the driver P.

According to the present invention, when the specific passenger approaches the door of the vehicle 10 at the driver's seat, the bottom portion of the door is illuminated in a cooler or in a manner that is suitable for the specific passenger. Thus, even before the passenger gets into the vehicle, it can be detected whether or not a transmitter possessed by the specific passenger is using his/her own transmitter 6.

According to a common keyless entry system, in order to prevent an unnecessary unlock operation, the door is unlocked when a driver possessing the transmitter 6 touches the door handle. In this configuration, the seat 7 and the steering device 8 start to be adjusted so as to be in the states that are suitable for the driver after the door is unlocked on the basis of the driver's touch to the door handle. Because a short time period is given after the door is unlocked until the driver gets into the vehicle, it is difficult for the seat 7 and the steering device 8 to be adjusted so as to be in the states that are suitable for the driver within this limited time period.

In order to complete the seat state adjustment and the steering device adjustment within the time period after the door is unlocked until the driver gets into the vehicle, the speed of the actuation of the seat control device 3 or the like may be improved. To accomplish this operation, a mechanism of the seat control device 3 or the like needs to be enlarged, as a result, costs and the amount of energy consumption are increased. According to the vehicle entry system 1 of the present invention, although there is no need to enlarge the mechanism of the vehicle entry system 1, the driver can smoothly get into the vehicle and be seated on the seat.

In a configuration where the states of the seat 7 and the steering device 8 start to be adjusted at the time when the door lock is unlocked, if the driver is changed to the other diver without locking the door, the seat 7 and the steering device 8 cannot be automatically adjusted so as to be in states that are suitable for the other driver. According to the present invention, regardless of whether the door is locked or unlocked, when the driver P approaches the driver's seat, strictly speaking, when the driver P approaches the antenna 5a of the wireless transceiver 5 at the driver's seat side, the vehicle body control device 2 starts to control the seat 7 and the steering device 8 so as to be in the states that are suitable for the driver. Thus, even when the driver is changed to the other driver without locking the door, the seat 7 and the steering device 8 are adjusted so as to be in the states that are suitable for the other driver.

According to the embodiment of the present invention, the vehicle entry system is applied to the driver's seat, however, the vehicle entry system of the present invention may be applied to the other seats such as a passenger's seat having a seat control device. Specifically, when the seat includes a supporting mechanism by which the seat is rotated so as to face the door opening so that the passenger is easily seated on the seat, the seat can be rotated while the door opening operation has been completed, as a result, the passenger is smoothly seated on the seat.

According to the embodiment, the wireless transceiver 5 is used as means for detecting if the passenger is approaching the vehicle, however, other configuration may be used alternatively. For example, the passenger may be detected by using a method such as a voice print matching (voice recognition) or the like.

The hardware configuration and the flowchart of the program described in the embodiment are examples of the present invention. The hardware configuration and the flowchart of the program may be modified.

As mentioned above, the vehicle body control device 2 is composed of the control portion 21, the main memory portion 22, the external memory portion 23, the input portion 24, the output portion 26 and the internal bus 20. The main element of the control device 2 which processes the operation of the vehicle entry system 1 may be an existing ECU, and may not be an exclusive ECU. The vehicle body control device 2 may be composed of a computer program for executing the abovementioned operation that is installed into the computer using a memorizing media such as a flexible disk, CD-ROM, DVD-ROM or the like. Further, the computer program may be stored in a memorizing device that is provided at a server device on a network such as the Internet, and the computer program may be downloaded to each local computer system.

When the function of the vehicle body control device 2 is assigned to each of OS (operation system) and the application program, or is cooperated by OS and the application program, only the application program may be stored in the memorizing media or the memorizing device.

The computer program may be superposed on a carrier wave and provided by means of a communication network. For example, the computer program is uploaded to BBS (Bulletin Board System) in order to be distributed through the communication network. In this configuration, the computer program is executed under the control of OS together with other application programs.

According to the vehicle entry system of the present invention, at the time when it is detected that the passenger is approaching the vehicle, the seat and the steering device start to be adjusted so as to be in the state and the angle that are suitable for the specific passenger. Thus, the adjusting operation of the seat and the steering device requires less time, as a result, the passenger can smoothly enter the vehicle and be seated on the seat that is suitable for the body type or the preference of the passenger.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A vehicle entry system comprising:
a portable device including a transmitter executing a communication between the portable device and a vehicle;
approach detecting means detecting an approach to the vehicle of a specific passenger possessing the portable device, by way of receiving an identification code of the specific passenger outputted by the transmitter of the portable device to the vehicle;
first adjusting means adjusting a state of a seat of the vehicle;
second adjusting means adjusting a state of a steering device of the vehicle;
memorizing means memorizing a state of the seat and a state of the steering device suitable for the specific passenger; and
control means controlling the first adjusting means in order to adjust the seat so as to be in the memorized state that is suitable for the specific passenger and controlling the second adjusting means in order to adjust the steering device so as to be in the memorized state that is suitable for the specific passenger, at a timing when the approach detecting means receives the identification code of the specific passenger approaching the vehicle.

2. The vehicle entry system according to claim 1, wherein the approach detecting means recognizes and detects that any of/one of the plural specific passengers is approaching, the memorizing means memorizes states of the seat and the steering device of each specific passenger, the control means controls the first adjusting means to adjust the seat so as to be in the memorized state that is suitable for the specific passenger and controls the second adjusting means to adjust the steering device so as to be in the memorized state that is suitable for the specific passenger.

3. The vehicle entry system according to claim 1 further includes an illuminating means illuminating a bottom portion of a door when the specific passenger approaches the vehicle, wherein an illuminating pattern is changed depending on the specific passenger.

4. The vehicle entry system according to claim 1, wherein the first adjusting means and the second adjusting means actuate the seat and the steering device so as to adjust one of or any combination of a state of the seat in a front-rear direction, a height of the seat, an angle of a seat back of the seat, a length of a seating surface of the seat, a horizontal rotation of the seat, a tilt angle of a steering wheel and a steering column of the steering device and a telescopic movement of the steering column of the steering device.

5. A vehicle entry system comprising:
a portable device including a transmitter executing a communication between the portable device and a vehicle;
approach detecting means detecting an approach to the vehicle of a specific passenger possessing the portable device, by way of receiving a identification code of the specific passenger outputted by the transmitter of the portable device to the vehicle;
first adjusting means adjusting a seat of the vehicle;
second adjusting means adjusting a steering device of the vehicle;
memorizing means memorizing a state of the seat and a state of the steering device suitable for the specific passenger;
an approach detecting process in which the approach detecting means receives the identification code of the specific passenger approaching the vehicle; and
a control process in which the first adjusting means is controlled in order to adjust the seat so as to be in the memorized state that is suitable for the specific passenger and the second adjusting means is controlled in order to adjust the steering device so as to be in the memorized state that is suitable for the specific passenger, at a timing when the identification code of the specific passenger approaching the vehicle is detected in the approach detecting process.

6. The vehicle entry system according to claim 3, wherein color and flashing intervals of the illuminating means are changed depending on the specific passenger.

7. The vehicle entry system according to claim 1, wherein the memorizing means memorizes a selected sound that indicates the specific passenger, and when the specific passenger approaching the vehicle is detected, the control means outputs the selected sound.
